(19) United States
(12) Patent Application Publication
(10) Pub. No.: US 2006/0141299 A1
(43) Pub. Date: Jun. 29, 2006

(54) Detecting and handling a fault condition in a fuel cell system

(76) Inventor: Nicola Piccirillo, Scotia, NY (US)

Correspondence Address: TROP PRUNER & HU, PC, 8554 KATY FREEWAY, SUITE 100, HOUSTON, TX, 77024, US

(21) Appl. No.: 11/022,334

(22) Filed: Dec. 23, 2004

(51) Int. Cl. H01M 8/04; G05F 1/00

(52) U.S. Cl. 429/13; 429/22; 700/286

(57) ABSTRACT

A technique that is usable with a fuel cell system includes comparing at least one parameter of the fuel cell system to a predetermined signature to identify an entity of the fuel cell system, which possibly caused a fault condition in the fuel cell system. The technique includes operating the fuel cell system to change the parameter(s); and in response to this operation, the technique includes determining whether the identified entity caused the fault condition.

### BACKGROUND

The invention generally relates to detecting and handling a fault condition in a fuel cell system.

A fuel cell is an electrochemical device that converts chemical energy produced by a reaction directly into electrical energy. For example, one type of fuel cell includes a polymer electrolyte membrane (PEM), often called a proton exchange membrane, that permits only protons to pass between an anode and a cathode of the fuel cell. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack is one out of many components of a typical fuel cell system, as the fuel cell system includes various other components and subsystems, such as a cooling subsystem, a cell voltage monitoring subsystem, a control subsystem, a power conditioning subsystem, etc. The particular design of each of these subsystems is a function of the application that the fuel cell system serves.

During the lifetime of the fuel cell system, there is a likelihood that at least one component of the fuel cell system may fail and cause a fault condition (a low cell voltage or a low cell signal-to-noise ratio, for example) in the system. Although the fault condition may be relatively easy to detect, it may be relatively more difficult to identify which component of the fuel cell system caused the fault condition. Shutting down the fuel cell system for purposes of determining which component caused the fault condition may not be an economically efficient solution.

Thus, there is a continuing need for better ways to diagnose and handle a fault condition in a fuel cell system.

### SUMMARY

In an embodiment of the invention, a technique that is usable with a fuel cell system includes comparing at least one parameter of the fuel cell system to a predetermined signature to identify an entity of the fuel cell system, which possibly caused a fault condition in the fuel cell system. The technique includes operating the fuel cell system to change the parameter(s); and in response to this operation, the technique includes determining whether the identified entity caused the fault condition.

Advantages and other features of the invention will become apparent from the following drawing, description and claims.

### BRIEF DESCRIPTION OF THE DRAWING

FIGS. 1 and 2 depict techniques to detect a fault condition in a fuel cell system and identify an entity that caused the fault condition according to embodiments of the invention.

FIG. 3 is a flow diagram depicting a technique to handle a fault condition in a fuel cell system according to an embodiment of the invention.

FIGS. 4 and 5 are tables depicting relationships between defective entities and corresponding fault conditions and test procedures according to an embodiment of the invention.

FIGS. 6 and 7 are block diagrams of fuel cell systems according to embodiments of the invention.

### DETAILED DESCRIPTION

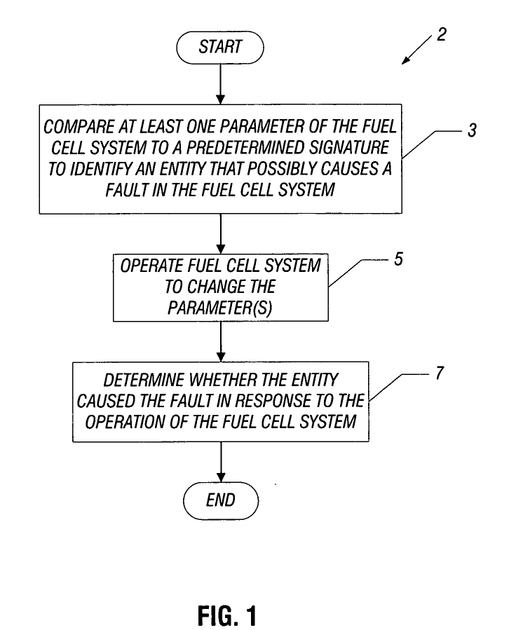

Referring to FIG. 1, in accordance with some embodiments of the invention, a technique 2 to detect and handle a fault condition in a fuel cell system involves initially recognizing the fault condition. In this regard, the technique 2 includes comparing (block 3) parameters (parameters labeled “critical parameters” herein and may include temperatures, cell voltages, flow rates, composition, cell signal-to-noise ratios, emission levels, relative humidity (RH) etc.) of the fuel cell system to predefined specifications to determine whether a fault condition exists. As more specific examples, the critical parameters may include a carbon monoxide level, an RH level, a hydrogen flow to the fuel cell stack, an oxygen flow to the fuel cell stack, etc. The parameters that are compared may be system parameters that are directly measured by dedicated sensing devices of the fuel cell system and/or may be estimated or calculated based on other measured system parameters. It is noted that the fuel cell system is a collection of components and serviceable subsystems that have critical specifications (e.g., dimensions, catalyst area, catalyst density, CV's on valves, etc.) that enable the control subsystem of the fuel cell system to deliver the critical parameters within reasonable margins.

A fault condition signifies that one of the monitored critical parameters of the fuel cell system is outside of its specified range. This quite often means, a particular process (a CO process, for example) is not working properly in the fuel cell system due to the failure of a particular “entity,” such as a component, subsystem, or subassembly (containing one or more individual components that may have failed) of that process. Herein the phrase “serviceable subassembly” is used to refer to a subassembly or subsystem of the fuel cell system, which can be replaced as a unit.

As a more specific example, a CO process in the fuel cell system may fail and thus, produce an unacceptably high level of CO that causes a fault condition. The CO process may include, for example, a CO oxidizer, an air valve and an air valve controller, each of which may fail or work improperly to cause overall failure of the CO process.

However, the CO process may not be the only cause of the critical CO parameter being out of bounds. For example, the high CO level may also be attributable to a defective shift reactor process.

As a result of the high CO level, fuel cells of the fuel cell stack may have low signal-to-noise ratios and may have low terminal voltages. Thus, these parameters may be recognized (pursuant to block 3 of FIG. 1) by the fuel cell system as following a signature that is indicative as a fault condition and allow at least one way to determine whether the CO critical parameter is within bounds.

Still referring to FIG. 1, the low cell signal-to-noise ratios and cell voltages, do not, however, discriminate which component, subsystem or subassembly (i.e., which “entity”) of the fuel cell system has failed, as one or more components, subsystems or subassemblies (the subassembly of the CO process or the subassembly of the shift reactor process in this example) of the fuel cell system may cause the same behavior. Therefore, for purposes of determining which particular entity has failed, the technique 2 operates (block 5) the fuel cell system to change the observed parameter(s). This operation, in turn, targets a suspected failed entity (component/subsystem/subassembly) because if the observed parameter(s) change in accordance with a predetermined signature in response to the operation, then the fuel cell system has identified the defective entity, as depicted in block 7.

To further illustrate an application of the technique 2, due to a detected high CO level (as an example), the fuel cell system may initially assume that the CO oxidation process is defective. With this assumption, the fuel cell system is operated to increase the air flow to the CO oxidizer of the fuel cell system. In less than a minute, if the entity that controls the CO oxidization process has failed, then the cell voltages and signal-to-noise ratio (i.e., the observed “parameters”) change. For this example, this means that if the entity that controls the CO oxidation process has failed, then the cell voltages increase and the signal-to-noise ratios of the fuel cells of the fuel cell stack improve in response to the flow of air to the CO oxidizer being increased.

If, however, the observed parameter(s) do not change, then another entity (component/subsystem/subassembly) may be the source of the fault condition. Continuing the example above, if the increase in air flow to the CO oxidizer does not produce the expected increases in the cell voltages and signal-to-noise ratios, then the fuel cell system may target another entity as possibly causing the fault condition. For example, if increasing the air flow to the CO oxidizer does not raise the cell voltages and signal-to-noise ratios as expected, then the fuel cell system operates to target the shift reactor (another potential cause of the high CO level) of the system.

To target the shift reactor, the fuel cell system operates in the following manner: the fuel cell system increases the air to the shift reactor to increase the oxygen to carbon ratio, and the fuel cell system increases the fuel to the shift reactor used for purposes of humidification.

In response to this operation of the fuel cell stack, the fuel cell system observes the same pattern (cell voltages and signal-to-noise ratios). If the cell voltages increase and the signal-to-noise ratios increase over a particular time interval (less than one minute, for example) then the shift reactor is identified as the defective component.

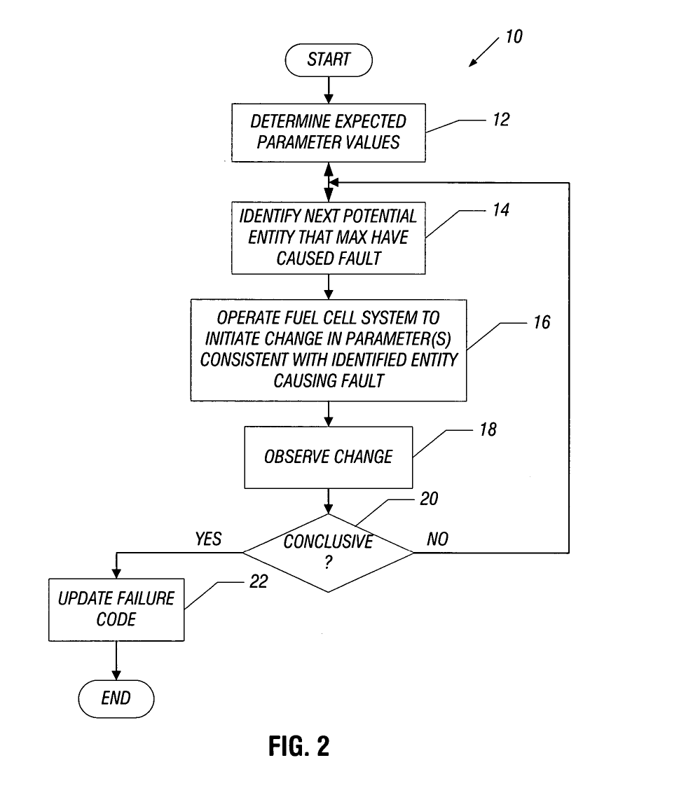

Therefore, referring to FIG. 2, in accordance with some embodiments of the invention, a technique 10 may be used for purposes of identifying a defective entity that caused a fault condition in a fuel cell system. The technique 10 includes determining (block 12) the values of one or more parameters (of the fuel cell system) that identify one or more particular entities of the fuel cell system as potentially causing the fault condition. Assuming that multiple entities may cause a particular fault condition, the technique 10 includes identifying (block 14) the next potential entity that may be the cause of the fault condition. This begins a loop in which the potentially defective entities are evaluated, one at a time, for purposes of specifically identifying which one caused the fault condition.

In this loop, the technique 10 includes operating (block 16) the fuel cell system to initiate a change in one or more parameters consistent with the identified entity having caused the fault condition. The change is observed (block 18), and if the observed change is conclusive (diamond 20), then the loop ends, as the failure code is updated (block 22) to identify the defective entity. Otherwise, if blocks 16 and 18 do not produce conclusive results, the loop continues and control transitions back to block 14.

It is noted that in some embodiments of the invention, the fuel cell system uses the techniques that are disclosed herein to narrow down the number of potentially defective entities (components/subsystems/subassemblies). Thus, sometimes, the techniques that are disclosed herein may be used to narrow the potentially defective entities down to a number greater than one (such as two, for example). Even though the specific defective component/subassembly may not be identified, fewer components or subsystems need to be evaluated in a service call, for example. Thus, in the context of this application, the identified “entity” may include multiple potentially-defective components, subsystems or subassemblies.

The detection of a fault condition in the fuel cell system may transition the fuel cell system from a normal mode of operation (the mode of operation when no fault conditions exist) into a fault tolerant mode of operation, in some embodiments of the invention. Thus, in these embodiments of the invention, the techniques 2 and 10 described herein may be performed by the fuel cell system in the fault tolerant mode of operation and may last until the fault condition is corrected. Therefore, in accordance with some embodiments of the invention, the fault mode of operation of the fuel cell system continues until the defective component is repaired through operation of the fuel cell system or the shutting down and repair of the fuel cell system via a service call.

For certain circumstances (described below), the fault condition may be reversible without requiring the shutting down the fuel cell system. For such a reversible fault condition, the fuel cell system is operated to effectively reverse the fault condition and take the fuel cell system out of the fault tolerant mode. If, however, the fault is not reversible, then the fuel cell system makes a determination regarding the timing for a service call to service or replace the defective entity that caused the fault condition.

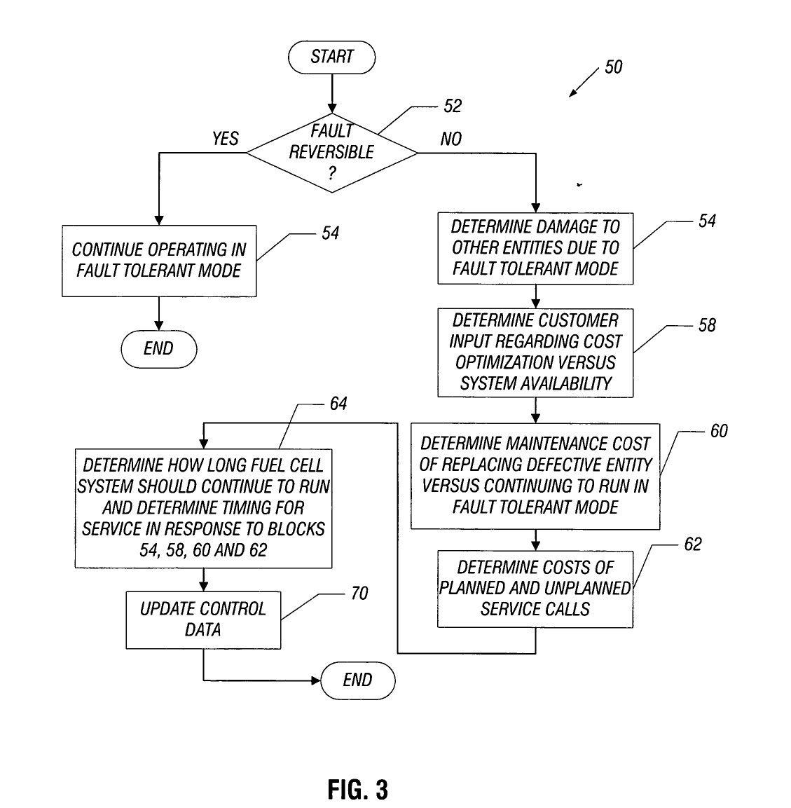

More specifically, referring to FIG. 3, in some embodiments of the invention, a technique 50 may be used by the fuel cell system after the defective entity that caused the fault condition has been identified. Pursuant to the technique 50, a determination is made (diamond 52) whether the fault is reversible. For the high CO level example that is described herein, increasing the air flow to the CO oxidization process remedies any associated defect in this process and increasing the air-to-fuel ratio of the shift reactor remedies any defect with the shift reactor.

Some faults, however, cannot be reversed, and thus, the defective entity cannot be repaired. For example, a fault condition may arise when an insufficient level of oxygen is being provided to the fuel cells. For this fault condition, either the air blower to the fuel cell stack or a membrane in the fuel cell stack may have failed. However, either a failure in the air blower or a failure in the membrane is not reversible via operation of the fuel cell system, in some embodiments of the invention.

If the fault is not reversible, then the fuel cell system takes into account several considerations to plan the timing of the repair and/or replacement of the defective entity via a service call. For example, in some embodiments of the invention, the fuel cell system determines (block 54) the damage to other components of the fuel cell system due to operation of the fuel cell system in the fault tolerant mode.

Therefore, for example, if by operating in the fault tolerant mode, significant damage may have occurred to other fuel cell system components, then a relatively sooner service call is scheduled. However, if by operating in the fault tolerant mode, significant damage has not occurred to any other component of the fuel cell system, then a relatively later service call may be scheduled.

As another example of a consideration for planning the service call, the fuel cell system may determine (block 58) customer input regarding cost optimization and system availability. Thus, for example, the customer of the fuel cell system may suffer more economic damage, for example, due to shutdown of the fuel cell system than the cost incurred to the system due to the continued running of the fuel cell system with the defective component. Furthermore, the customer may specify a certain fuel cell system cost level that triggers a service call; may specify that the fuel cell system, if possible, should only be shut down during certain days or hours; etc. Therefore, all or some of these factors may influence when the fuel cell system schedules a service call.

As yet another example of the considerations that are taken by the fuel cell system, in some embodiments of the invention, the fuel cell system may determine (block 60) the maintenance cost of replacing the defective entity versus the cost that is attributable to continuing to run the system in the fault tolerant mode. Therefore, for example, if no further damage occurs to other components of the fuel cell system, then the fuel cell system may schedule a service call solely based on other factors, as the timing does not affect future operation of the fuel cell system. Furthermore, the fuel cell system may determine (block 62) the cost of planned and unplanned service calls when making the determination of when to schedule service.

Therefore, in accordance with the technique 50, in some embodiments of the invention, the fuel cell system determines (block 64) how long the fuel cell system should continue to run (and thus, when the service call should occur) in response to blocks 54, 58, 60 and 72 of the technique 50. Subsequently, the fuel cell system updates (block 70) control data that indicates when the service call should occur and which component(s) need to be repaired/replaced in the service call.

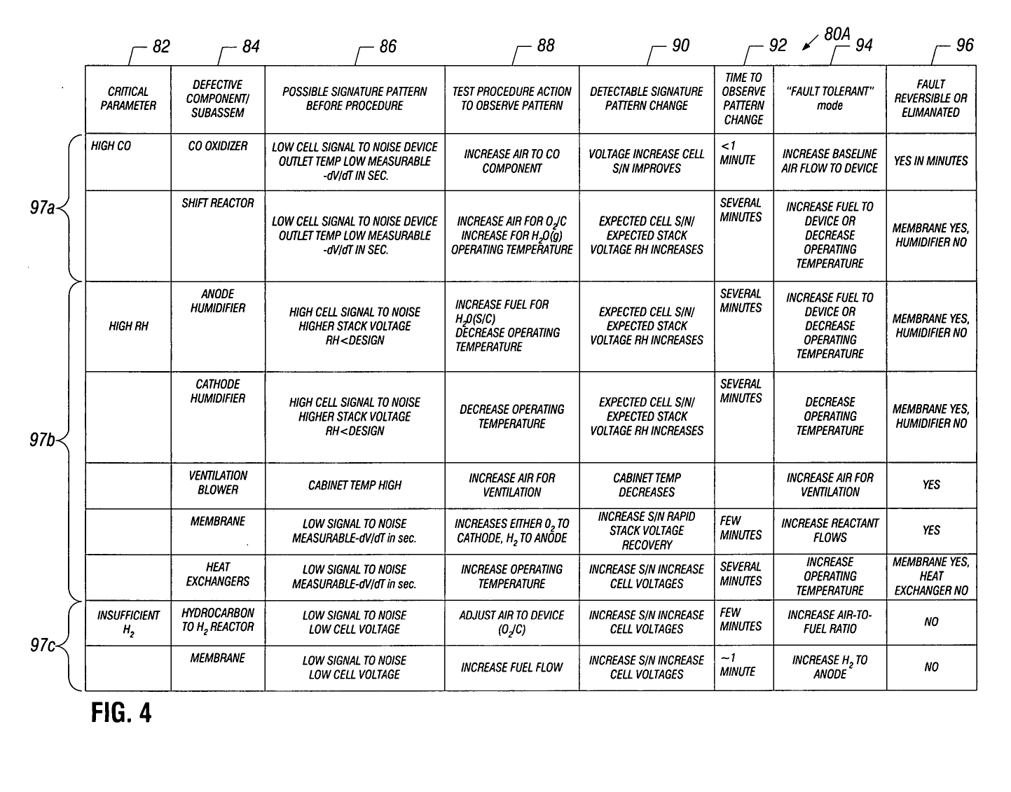

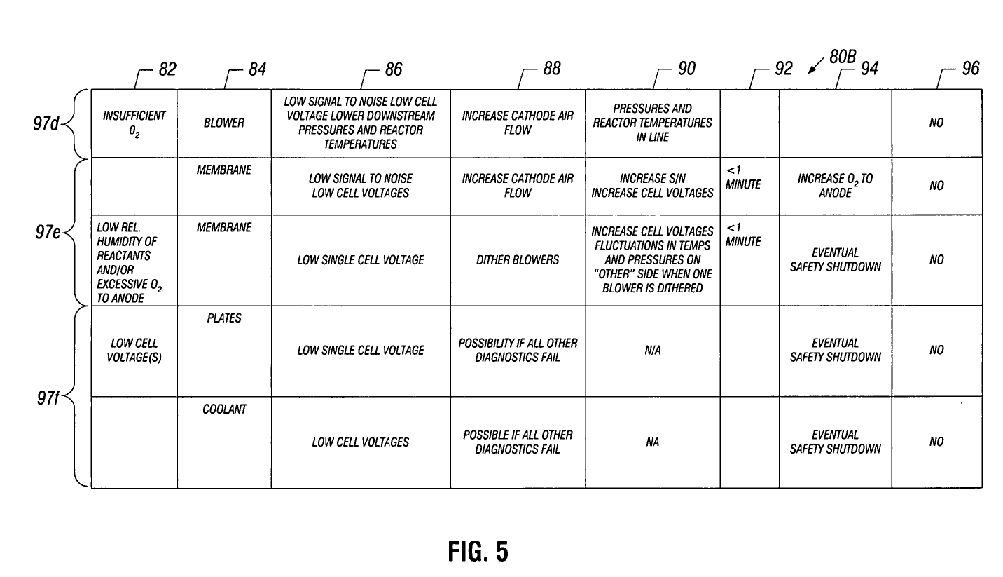

FIGS. 4 and 5 depict tables 80A (FIG. 4) and 80B (FIG. 5) that illustrate exemplary signatures and test procedures for identifying a defective entity associated with a fault condition and illustrate remedies for the various fault conditions. The tables 80A and 80B each includes a column 82 that lists critical parameters that may fall outside of a predefined range and trigger a fault condition. Each critical parameter that is listed in column 82 is associated with one or more rows of the tables 80A and 80B, and each of these rows is associated with a potentially defective entity that is listed in column 84. For example, three rows 97a (FIG. 4) of the table 80A are associated with potentially defective entities that may have caused CO, a critical parameter, to rise above an acceptable level; five rows 97b of the table 80A are associated with potentially defective entities that may have caused the relative humidity (RH) a critical parameter, to rise above an acceptable level; two rows 97c of the table 80A are associated with potentially defective entities that may have caused an insufficient level of hydrogen, a critical parameter; two rows 97d (FIG. 5) of the table 80B are associated with potentially defective entities that may have caused the oxygen level, a critical parameter, to be insufficient; one row 97e of the table 80B is associated with a membrane that may have caused the RH of the reactants (a critical parameter) to be low or excessive oxygen in the anode, another critical parameter; and lastly, two rows 97f of the table 80B are associated with potentially defective entities that may have caused the cell voltages, critical parameters, to individually or collectively fall below acceptable levels.

The tables 80A and 80B have a column 86 that identifies a signature that is associated with a possible fault condition. As an example, in both rows 97, the same signature exists in column 86. Thus, analyzing a signature alone for purposes of identifying a defective component that caused a fault condition is not by itself determinative. Therefore, the above-described operation of the fuel cell system is used for purposes of identifying the defective entity.

In this regard, the tables 80A and 80B include a column 88 of test procedures that are used to discriminate between potentially defective entities. For example, for the rows 97a (FIG. 4) that are associated with the high CO level, the row 97a that is associated with a potential defective CO oxidation process includes a test procedure (in column 88) of increasing air to the CO oxidizer. A different test procedure is identified in column 88 for the row 97a that is associated with a potentially defective shift reactor.

The tables 80A and 80B also each includes a column 90 that identifies a detectable signature change that is associated with the test procedure that is set forth in column 88. Furthermore, the tables 80A and 80B include a column 92 that depicts a time to observe the pattern change. Therefore, for example, the time that is associated with detecting the defective component for a high CO level is less than about one minute. In contrast, referring to column 92 of row 97e (FIG. 5), the time to detect whether a membrane has failed may take a few minutes.

The tables 80A and 80B also each includes a column 94 that identifies an action to be taken in the fault tolerant mode once the associated entity has been confirmed to be defective. For example, for the rows 97a that are associated with a high CO level, the column 94 identifies increasing the baseline air flow device to the CO oxidation process, when the CO oxidation process is confirmed as failing; and the column 94 identifies increasing the air-to-fuel ratio of the shift reactor when the shift reactor is confirmed as being defective.

It is noted that operation of the fuel cell system in the fault tolerant mode does not necessarily reverse the fault, but rather, the operation at least attempts to preserve the ability of the fuel cell system to operate until a service call is performed to address the fault condition. For example, the row 97e (FIG. 5) sets forth a procedure when a membrane rupture causes a fault condition. As shown in column 94 of row 97e, the procedure includes the eventual safe shutdown of the fuel cell system.

Lastly, the tables 80A and 80B include a column 96 that identifies whether the fault condition is reversible. Therefore, for example, for the rows 97a that are associated with the high CO level fault condition, if the defect is attributed to either the CO oxidization process or the shift reactor, then the defect is reversible. This is to be contrasted with, for example, a fault condition that is caused by a membrane rupture (row 97e of FIG. 5) in which the fault condition is not reversible.

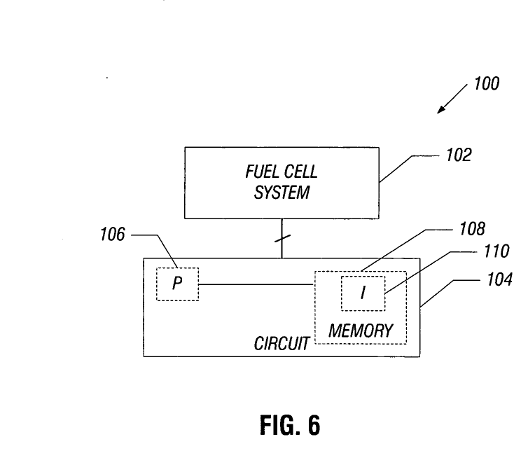

Referring to FIG. 6, in some embodiments of the invention, a system 100 may include a fuel cell system 102 whose potential fault conditions are diagnosed by a circuit 104. The circuit 104 may also control the behavior of the fuel cell system 102 after a detected fault condition; identify which component caused the fault condition; and may control the corrective action (if any) that is taken by the fuel cell system in accordance with the techniques that are disclosed herein. The circuit 104 may be part of the fuel cell system 102 in some embodiments of the invention.

As depicted in FIG. 6, the circuit 104 includes a processor 106 (one or more microcontrollers or microprocessors, for example) that is coupled to a memory 108. The memory 108 may store instructions 110 that when executed by the processor 106 cause the circuit 104 to perform one or more of the techniques that are disclosed herein.

The action to take does not have to be determined solely by the controller. Fault alerts to the customer, service provider, or manufacturer could enable case-by-case decision making. Decisions may be executed locally or remotely. Service manuals/service software diagnostic procedures could also enable control parameters to be tuned to the new set of conditions, depending on the particular embodiment of the invention.

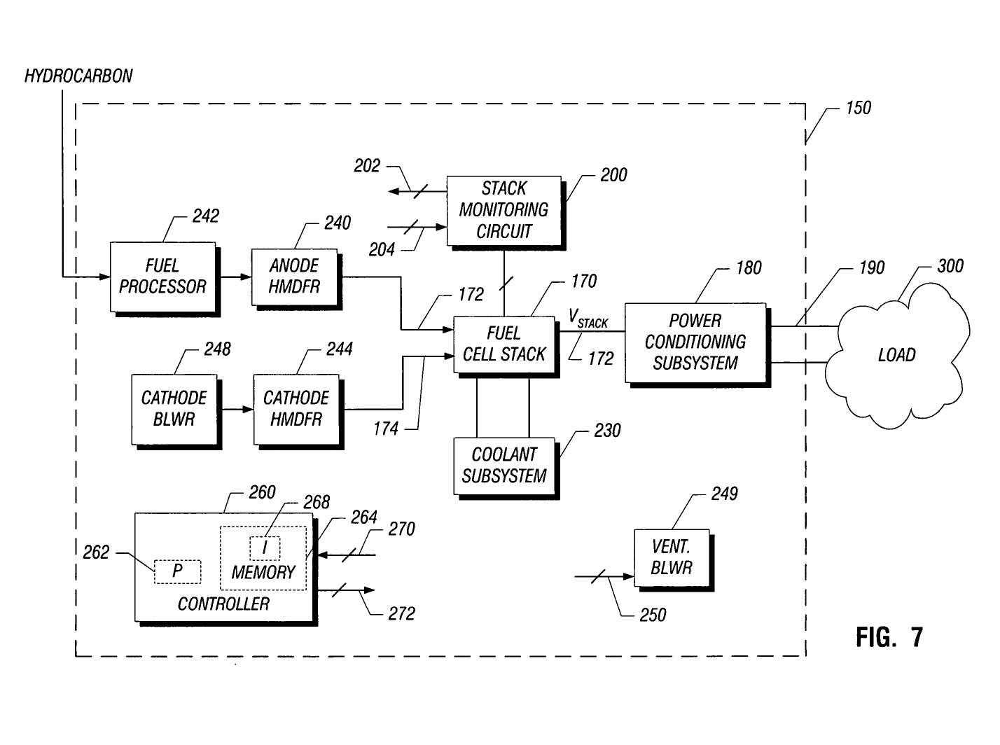

As a more specific example, FIG. 7 depicts a fuel cell system 150 in accordance with some embodiments of the invention. The fuel cell system 150 may supply power to a load 300. Depending on the particular application of the fuel cell system 150, the load 300 may be an AC load (the scenario depicted in FIG. 7) or a DC load.

In some embodiments of the invention, the fuel cell system 150 includes a fuel cell stack 170 that receives a fuel flow at an anode inlet port 172 and an oxidant flow at a cathode inlet port 174. In response to these flows, the fuel cell stack 170 produces a stack voltage (called “VSTACK”) that appears on a stack output line 172. A power conditioning subsystem 180 of the fuel cell system 150 converts the VSTACK voltage into an AC voltage (for the exemplary fuel cell system depicted in FIG. 7) that may appear, for example, on output terminals 190 that are coupled to the load 300.

The fuel cell system 150 may include various other subsystems and components, such as, for example, a stack monitoring circuit 200 that is coupled to the fuel cell stack 170 for purposes of monitoring the cell voltages of the fuel cell stack 170 and generally monitoring the health of the fuel cell stack 170. The stack monitoring circuit 200 may be in communication with one or more electrical communication lines 204 that communicate signals to direct the monitoring of the fuel cell stack 170 by the circuit 200. Furthermore, the stack monitoring circuit 200 may be in electrical communication with one or more electrical communication lines 202 for purposes of providing data to a controller 260 of the fuel cell system 150 regarding the monitored condition and cell voltages of the fuel cell stack 170.

In some embodiments of the invention, the controller 260 may include a processor 262 (one or more microcontrollers or microprocessors, for example) that is coupled to a memory 264 of the controller 260. The memory 264, in turn, may store instructions 268 that cause the processor 262, when executed, to perform one or more of the techniques 2, 10 and 50 that are described herein. Thus, the controller 260 may, for example, receive status information (via electrical communication lines 270) from various sensors and circuits (such as the stack monitoring circuit 200, for example) of the fuel cell system 150 and produce electrical control signals that propagate on electrical communication lines 272 to control the various components of the fuel cell system 150.

Thus, the controller 260 may, depending on the particular embodiment of the invention, recognize signatures that identify fault conditions, control the operation of the fuel cell system 150 to effect a change in a pattern to identify a defective entity, may analyze changes in observed parameters to identify failed entities, may control operation of the fuel cell system 150 after a particular defective entity is identified, may plan a shut down and/or service call to service a defective entity, etc.

In some embodiments of the invention, the fuel cell system 150 may include, for example, a coolant subsystem 230 that circulates a coolant through the fuel cell stack 170. Furthermore, in some embodiments of the invention, the fuel cell system 150 may include an anode humidifier 240 and a cathode humidifier 244 that provide respective humidified fuel and oxidant flows to the fuel cell stack 170. The anode humidifier 270 may receive its fuel flow, for example, from a fuel processor 242. The fuel processor 242 may include, for example, a CO oxidizer and a shift reactor, in some embodiments of the invention. Furthermore, the cathode humidifier 244 may receive its air flow from a cathode blower 248 of the fuel cell system 150. As also depicted in FIG. 7, in some embodiments of the invention, the fuel cell system 150 may include a ventilation blower 249 that is controlled (via electrical communication lines 250, for example) the controller 260 of the fuel cell system 150.

The components and subsystems that are depicted in FIG. 7 are simplified for purposes of illustrating basic components of the fuel cell system 150. However, it is understood that the fuel cell system may include various other components and subsystems and different components and subsystems, in other embodiments of the invention. Thus, many variations are possible and are within the scope of the appended claims.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method usable with a fuel cell system, comprising:
comparing at least one parameter of the fuel cell system to a predetermined signature to identify an entity of the fuel cell system possibly causing a fault condition in the fuel cell system;
operating the fuel cell system to change said at least one parameter; and
in response to the operating, determining whether the entity caused the fault condition.

2. The method of claim 1, wherein the entity comprises at least one of a component and a subassembly having multiple components.

3. The method of claim 1, wherein comparing comprises automatically comparing said at least one parameter to the predetermined signature.

4. The method of claim 1, wherein the determining comprises comparing the change in said at least one parameter to a predetermined change indicative of the entity causing the fault condition.

5. The method of claim 1, wherein the determining comprises determining the change is not indicative of the entity causing the fault condition.

6. The method of claim 1, wherein the operating comprises operating the fuel cell system in a fault condition tolerant mode other than a normal mode of operation in which the fuel cell system operates prior to the fault condition.

7. The method of claim 1, further comprising:
in response to the determination of whether the entity caused the fault condition, comparing said at least one parameter to another predetermined signature to identify another entity of the fuel cell system possibly causing the fault condition.

8. The method of claim 1, further comprising:
in response to the determination of whether the entity caused the fault condition, determining whether the fault condition is reversible.

9. The method of claim 8, further comprising:
if the fault condition is not reversible, determining how long the fuel cell system operates before being shut down.

10. The method of claim 9, wherein the determination of how long the fuel cell system operates before being shut down is based at least in part on the damage to entities other than a defective entity that caused the fault condition due to operation of the fuel cell system in a fault condition tolerant mode.

11. The method of claim 9, wherein the determination of how long the fuel cell system operates before being shut down is based at least in part on data input by a customer indicating a cost associated with shutting down the fuel cell system.

12. The method of claim 9, wherein the determination of how long the fuel cell system operates before being shut down is based at least in part on determination of maintenance cost of replacing a entity that caused the fault condition versus cost of continuing to operate fuel cell system in a fault condition tolerant mode.

13. The method of claim 9, wherein the determination of how long the fuel cell system operates before being shut down is based at least in part on a determination of the cost of an unplanned service call versus a planned service call to replace a defective entity that caused the fault condition.

14. The method of claim 1, wherein the fault condition is associated with at least one of the following defective entities: a carbon monoxide oxidization process, a shift reactor, a humidifier, a blower, a fuel cell membrane, a heat exchanger and a reformer.

15. The method of claim 1, wherein the operating comprises operating the fuel cell system for a time interval to change said at least one parameter dependent on a characteristic of the identified entity.

16. An apparatus comprising:
a fuel cell system; and
a circuit to:
compare at least one parameter of the fuel cell system to a predetermined signature to identify an entity of the fuel cell system that possibly caused a fault condition in the fuel cell system,
cause the fuel cell system to change said at least one parameter, and
in response to the operation, determine whether the entity caused the fault condition.

17. The apparatus of claim 16, wherein the entity comprises at least one of a component and a subassembly having multiple components.

18. The apparatus of claim 16, wherein the circuit is adapted to compare the change in said at least one parameter to a predetermined change indicative of the entity causing the fault condition.

19. The apparatus of claim 16, wherein the circuit is adapted to, in response to the determination of whether entity cause the fault condition, compare said at least one parameter of parameters to another predetermined signature to identify another entity that possibly caused the fault condition.

20. The apparatus of claim 16, wherein the circuit is adapted to, in response to the determination of whether the entity caused the fault condition, determine whether the fault condition is reversible.

21. The apparatus of claim 20, wherein the circuit is adapted to determine how long the fuel cell system operates before being shut down if the fault condition is not reversible.

22. The apparatus of claim 16, wherein the circuit is adapted to operate the fuel cell system for a time interval to change said at least one parameter dependent on a characteristic of the entity causing the fault condition.

23. The apparatus of claim 16, wherein the circuit is part of the fuel cell system.

24. The apparatus of claim 16, wherein the fault condition is associated with at least one of the following defective entities: a carbon monoxide oxidation process, a shift reactor, a humidifier, a blower, a fuel cell membrane, a heat exchanger and a reformer.

25. An article comprising a computer readable storage medium storing instructions to cause a processor-based system to:
compare at least one parameter of a fuel cell system to a predetermined signature to identify a entity that possibly caused a fault condition in the fuel cell system,
cause the fuel cell system to change said at least one parameter, and
in response to the operation, determine whether the entity caused the fault condition.

26. The article of claim 25, the storage medium storing instructions to cause the processor-based system to compare the change in said at least one parameter to a predetermined change indicative of the entity causing the fault condition.

27. The article of claim 25, the storage medium storing instructions to cause the processor-based system to, in response to the determination of whether the entity caused the fault condition, compare the said at least one parameter to another predetermined signature to identify another entity that possibly caused the fault condition.

28. The article of claim 25, the storage medium storing instructions to cause the processor-based system to, in response to the determination of whether the entity caused the fault condition, determine whether the fault condition is reversible.

29. The article of claim 28, the storage medium storing instructions to cause the processor-based system to determine how long the fuel cell system operates before being shut down if the fault condition is not reversible.
